(19) United States
(12) Patent Application Publication
(10) Pub. No.: US 2007/0052804 A1
(43) Pub. Date: Mar. 8, 2007

(54) MOBILE VIDEO SURVEILLANCE SYSTEM AND METHOD

(76) Inventors: James Keith Money, Heathrow, FL (US); William Ross Walker, Sanford, FL (US)

Correspondence Address: WILDMAN HARROLD ALLEN & DIXON, 225 WEST WACKER DRIVE, SUITE 2800, CHICAGO, IL, 60606, US

(21) Appl. No.: 11/383,797

(22) Filed: May 17, 2006

Related U.S. Application Data
(60) Provisional application No. 60/715,709, filed on Sep. 7, 2005.
(60) Provisional application No. 60/715,707, filed on Sep. 7, 2005.

(51) Int. Cl. H04N 7/18

(52) U.S. Cl. 348/143

(57) ABSTRACT

A mobile video surveillance system is provided having portable video units communicating in a wireless network. The individual portable video units have a wireless router coupled to a video camera that is held by a portable mounting device. The wireless routers coupled to the video cameras, at the deployed portable video units, transmit video data via the wireless network to a wireless router that is coupled with a video server. The video server receives video data from the portable video units for display at the video server.

### CROSS REFERENCE TO RELATED APPLICATIONS

This application claims priority from U.S. Provisional Patent Application Ser. No. 60/715,709 filed on Sep. 7, 2005 and U.S. Provisional Patent Application Ser. No. 60/715,707 filed Sep. 7, 2005.

### FIELD OF INVENTION

The present invention relates to video surveillance systems and more particularly to video surveillance systems operating in wireless broadband networks.

### BACKGROUND OF THE INVENTION

Many conventional surveillance systems are set up within a fixed infrastructure. Such surveillance systems may employ a tradition infrastructure such as wall mounts, electrical outlets, monitors, cables and the like in order to function. These fixed surveillance systems may not be highly effective in a tactical environment where mobility, portability and quick deployment of the surveillance equipment is desirable.

Hand-held or mobile surveillance devices often do not have the network connectivity needed to broadcast incoming video data to a centralized server such as a command center. Additionally, such hand-held devices often require close human interaction to be effective. Existing video surveillance systems may be considered cumbersome, expensive and ineffective to users operating in a tactical network environment. Tactical network environments, at times, may not have access to the infrastructure required to power equipment or transmit broadcasts in a secure and reliable manner. Accordingly, there is a need for a portable, secure, quickly deployable audio-visual mobile surveillance system for use in tactical environments.

### BRIEF DESCRIPTION OF THE DRAWINGS

Certain embodiments of the present invention are illustrated by the accompanying figures. It should be understood that the figures are not necessarily to scale and that details not necessary for an understanding of the invention or that render other details difficult to perceive may be omitted. It should be understood, of course, that the invention is not necessarily limited to the particular embodiments illustrated herein.

FIG. 1 is a system diagram depicting a mobile video surveillance system.

FIG. 2 depicts a portable video unit with a camera and a wireless router supported by a deployable mast.

FIG. 3 is an example display of multiple video images obtained through the mobile video surveillance system.

### DETAILED DESCRIPTION

A mobile video surveillance system is shown and described. To accomplish video surveillance, a number of portable video units are deployed at various locations in a selected area of coverage. The portable video units have a wireless router that is coupled with a video camera held by a portable mounting device. The portable video units communicate with each other and a video server having its own associated wireless router in a wireless network. The video server receives video data from video cameras of the portable video units for display of multiple video feeds at a display device associated with the video server. The wireless mobile network may, for example, be a mobile or ad-hoc network or a mesh network.

The portable mounting device for the portable video units may, for example, include a mast having a tripod base for supporting and positioning the video cameras and their associated routers at various selectable locations in the area of coverage. Each of the video cameras is elevated from the ground surface, for example, by the portable mast having a the tripod base. The wireless routers coupled with the video cameras at the portable video units transmit video data to a wireless router coupled with the video server for real-time display of multiple video images captured by the video cameras. The video server, in this example, includes a network video recorder running video management software for simultaneous viewing of multiple video feeds. Control of the videos surveillance is performed at the video server with the network video recorder being configured to further provide instant notification, motion detection and archiving capabilities.

The cameras, routers and masts of the portable video units are able to be deployed and set up for communication at various random locations in the wireless network area of communication. The portable video units are able to continue to communicate with each other and the video server when one or more of the portable video units are moved from location to location within the wireless network range of communication. The wireless routers of the portable video units are each connected to a corresponding portable power source (such as a 12 volt battery). An Ethernet connection and a power connection couple each of the video cameras and wireless routers to provide power and video data connectivity at the portable video units deployed throughout the network.

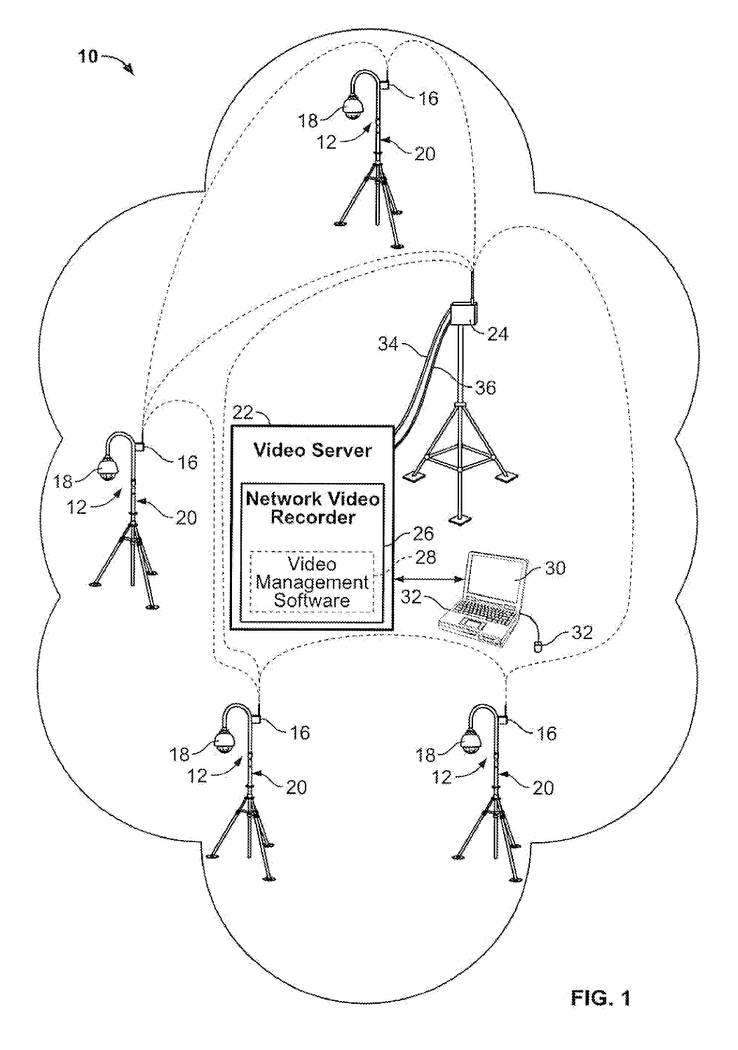

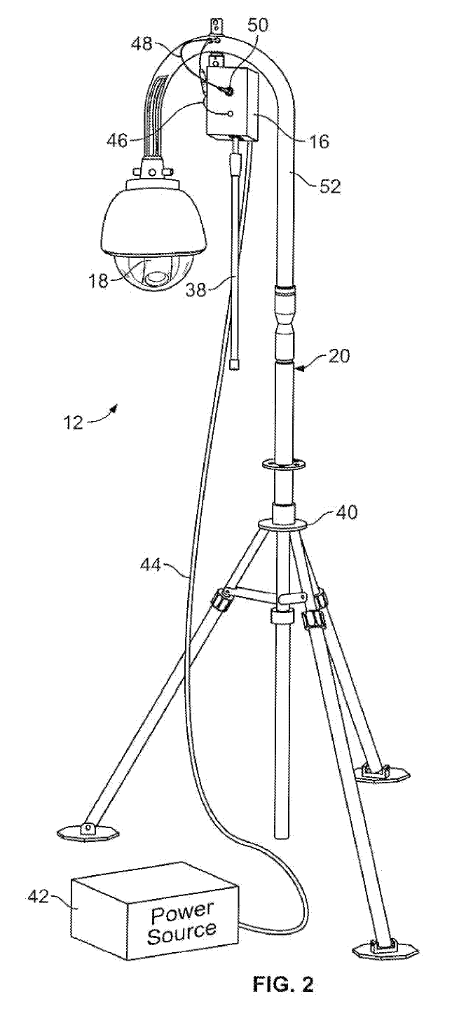

Referring to FIG. 1, mobile video surveillance system 10 is shown with portable video units 12 communicating and routing video data within wireless network 14. The individual portable video units 12, in this example, each have a wireless router 16 coupled for communication with an associated video camera 18 that are held and supported by a portable mounting device 20. In the example seen in FIGS. 1 and 2, the wireless router and video camera are separately housed devices; however, it is understood that the wireless router and video camera may be combined in a single network device. Video data obtained by the video cameras 18, FIG. 1, are transmitted by the wireless routers 16 via the wireless network 14 to video server 22. Video server 22 is coupled for communication with an associated wireless router 24. Wireless router 24 receives the video images obtained from the video camera 18 in data packets that are transmitted from the wireless routers 16 of the portable video units 12 deployed throughout the wireless network 14. The video server 22, in this example, has network video recorder 26 with associated video management software 28 for providing management of video feeds received and remote control of the video cameras 18 placed within the wireless network range of coverage.

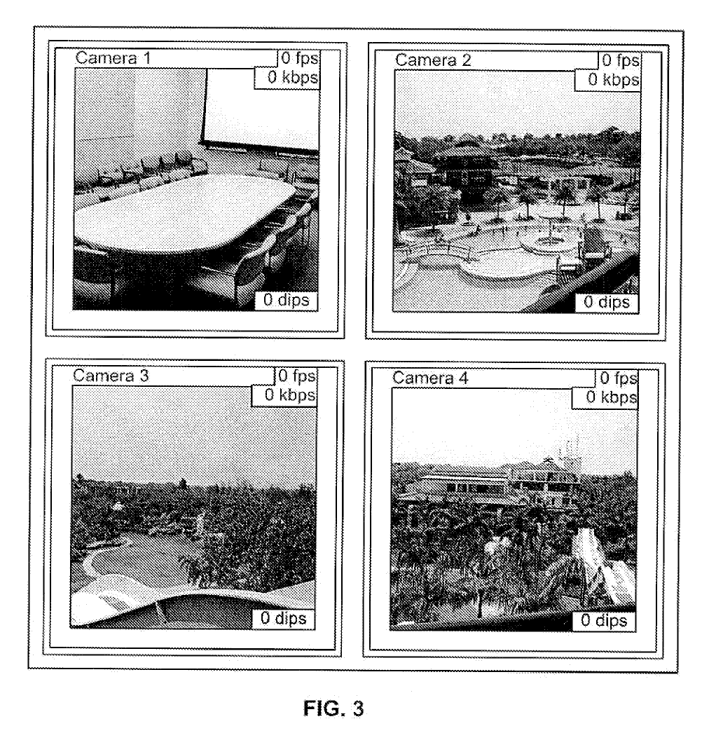

Control and monitoring of video surveillance operations is performed at the video server 22. Video server 22 is coupled with an associated display device 30 and user input interface 32 (such as a keyboard, mouse, touchscreen, or any other data input device) to provide a user with video monitoring and control capabilities from a central location such as a surveillance command center. The network video recorder 26 receives video data from the portable video units 12 deployed at various locations throughout the wireless network 14 for simultaneous display and viewing of multiple video feeds on the display device 30 at the video server 22. An example display of multiple video images for viewing at the display device 30 is seen in FIG. 3. The portable video units 12 continue to communicate with each other and the video server 22 even as one or more of the portable video units are moved to different locations within the wireless network range of communication.

In the example seen with reference to FIG. 1, the mobile video surveillance system 10 is provided with four video cameras 18 attached to four wireless routers 16; however, a fewer or greater number of portable video units may be employed. The wireless routers 16 are attached to four mobile portable mounting devices 20 to broadcast video data over the wireless network 14 to the network video recorder 26 of the video server 22 for viewing (as seen in the display of FIG. 3) and archiving. The video server 22, FIG. 1, also has an attached wireless router 24 to receive the video data from the wireless routers 16 of the portable video units 12. The wireless routers 16, 24 have an Ethernet port to provide communication with the video cameras 18 and the video server 22 as well as providing network connectivity. An example of a wireless router that may selectively be employed is an enhanced wireless router model number EWR 6300 DC sold by Motorola, Inc. The wireless routers provide wireless communication in a geographic range of coverage for the network and wireless network access to the video cameras (or other Internet Protocol-based devices) through an Ethernet port provided at each of the wireless routers.

The wireless network may for example be a mobile or ad-hoc network or a mesh network. Each of the wireless routers 16 coupled with the video cameras 18 and the wireless router 24 coupled with the video server 22 are pre-configured as network devices of the wireless network 14. Prior to deployment in the field, the wireless routers are assigned as being set for communication in the wireless network. The configuration on the wireless routers 16, 24, video cameras 18 and the video server 22 may be adapted, for example, such that they are assigned as devices for communication within the wireless network. A mobile or ad-hoc network is a self-configuring network of mobile network communication devices connected by wireless links, each network communication device being free to move randomly and organize arbitrarily. Thus, the topology for the network may dynamically change depending on the location of the various network communication devices. The mobile or ad-hoc network may be, for example, a local area network.

A mesh network is a network that routes data between nodes in the absence of a centralized server used for authentication. Mesh networks provide continuous connections and reconfiguration around blocked paths by hopping from node to node in the most efficient path possible (always searching for the shortest path between two points) until connections can be established. Mesh networks are self healing, which means that the network can still operate even when a node or other connection is inoperable. Each node within the network authenticates the others. The nodes may, for example, be network communication devices such as wireless routers. Nodes are spaced at distances from each other (e.g. 1.0 mile) in the local area of coverage for the wireless network. Increasing the number of wireless routers increases the distance the wireless network can span. The wireless network 14 may also be, for example, a self forming network such that the portable video units 12 are able to identify and communicate with additional portable video units that are added to the wireless network. For further details on the establishment, connectivity, and communication of such wireless networks, reference can be made to U.S. patent application Ser. No. 11/383,775 of Dumas et al. entitled “Apparatus and Method for Dynamically Updating and Communicating with Flexible Networks” filed on May 17, 2006 and assigned to the same assignee of the present application which is hereby incorporated by reference in its entirety.

The network video recorder 26 of video server 22 provides instant notification, motion detection, and archiving capabilities. The video management software 28 of the network video recorder 26 provides for configurable motion detection such that, for example, video recordation, or viewing based on motion detection is able to be set to particular quadrants of the viewable field (e.g. as seen in FIG. 3) as well as an entire field of view. Where the video surveillance system 10 detects motion, the video server 22 may selectively cause instant video recording of the cause of the motion, sound an alert or send a notification in the form of a secure instant message, e-mail or the like to other nodes (such as personal computer-based network communication devices—not shown) of the wireless network.

Archived video footage is viewable from any network communication device (such as a (Transmission Control Protocol/Internet Protocol) TCP/IP-configured device) on the wireless network that has a display device (for example, a laptop, personal computer, PDA (personal digital assistant), and the like) and compatible video viewing software. Monitoring and control of the video feeds are performed through the video management software 28 at the video server 22 in conjunction with user input provided through the user interface 32 and the display device 30 of the video server. Video management software that may selectively be employed, for example, is Sony RealShot Manager software sold by Sony Corporation. The video server 22 may also be provided with rack-mount speakers for the network video recorder 16 to send audible alerts.

The video cameras 18 employed may, for example, be pan-tilt-zoom Internet Protocol (IP)-enabled video cameras allowing camera movements with built-in JPEG and MPEG-4 compression along with audio-in, audio-out, 18× optical zoom and 12-volt power capabilities. The pan, tilt and zoom operation of the video cameras 18 are remotely controlled from the video server 22 via the wireless network 14. The wireless routers 16 of the portable video units 12 transmit video data received from the video cameras 18 to the wireless router 16 coupled with the video server 22 for real-time display at display device 30 of multiple video images captured by the video cameras.

Power and data communication are provided between the wireless router 24 and the video server 22 by power connection over power cable 34 and Ethernet connection over Ethernet cable 36. The video server 22 may receive power, for example, by an external AC or DC power source with an inverter, such as power received through a vehicle stationed at or carrying the video server 22 and wireless router 24. For example, video server 22 may be powered via a 110 volt AC power adapter or an inverter that supplies AC power. Connectivity between the wireless routers 16, 24 in the wireless network 14 allows for the recordation, display, monitoring and control of video feeds (obtained from one or more of the video cameras 18) by the video server 22 from a vehicle moving throughout the wireless network. The video server 22, wireless router 24, display device 30 and user interface 32 are able to be placed and operate within a vehicle such that control of the video camera operation via the user interface and the display of multiple video feeds received from the video cameras 18 are performed as the vehicle moves to different locations within the wireless network 14. The mobile video surveillance system 10 provides a portable, motion sensing IP-enabled video-capturing surveillance solution that is quickly deployable in various environments and non-permanent situations for tactical wireless network areas. The system is able to securely broadcast surveillance video to available nodes on the wireless network and archive the video feeds at the video server.

Referring now to FIG. 2, a portable video unit 12 is shown having video camera 18 coupled for communication with wireless router 16. The wireless router 16, in this example, has an antenna 38 (such as an 8dBi antenna) for transmitting video data through the wireless network 10. The video camera 18 and wireless router 16 are supported by and held above a ground surface by a portable mounting device. For example, as seen in FIG. 2, the portable mounting device may be a mast 20 having a tripod base 40. Power is provided to each of the portable video units 12 by a portable power source 42 such as a 12 volt battery. The portable power source 42 for each portable video unit 12 is coupled with a corresponding wireless router 16 by a power cord 44 to power the portable video unit. A power connection is made between the wireless router 16 and the video camera 18 through power cable 46.

An Ethernet cable 48 coupling the video camera 18 to the wireless router 16 via Ethernet port 50 provides an Ethernet connection for the transfer of radio-frequency signals between the wireless router and the video camera. As seen in FIG. 2, in this example, the portable mounting device 20 includes an inverted J-shaped pole that is releasably securable to the tripod base 40. The video camera 18 attached to an end of the curvilinear inverted J-shaped pole 52 such that the portable mounting device 20 places the video camera 18 in an elevated position for video surveillance over a selected area. The wireless router 16, in this example, is releasably mounted to the inverted J-shaped pole 52.

A method of deploying the mobile video surveillance system is provided. The method is performed by deploying individual portable video units at select geographic locations within a wireless network area of coverage. The portable video units each have a video camera coupled for communication with a corresponding wireless router which are supported by a portable mast having a tripod base. The video cameras are releasably secured at the portable masts and placed in elevated positions for video surveillance. A portable power source is connected to corresponding wireless routers at each of the portable video units. Video data is transmitted from the portable video units over the wireless network to the video server for display of multiple video images at a display device of the video server as seen in FIG. 3. One or more of the portable video units may selectively be moved to different geographic locations within the wireless network range of coverage while maintaining video communication over the wireless network with the video server. The video server may also be placed in a vehicle and simultaneous display of multiple video feeds on a display device of the video server may be performed as the vehicle moves to different locations in the wireless network range of coverage.

An expansion kit may also selectively be utilized to expand the geographic range of communication for an existing wireless network. The expansion system is quickly deployable, secure, and independent of network topology having the ability to transparently integrate with various networks using network configurable protocols. The expansion kit may comprise, for example, a mast, a wireless router with an associated antenna, power cord with a DC adapter, an AC-to-DC power adapter, a DC receptacle with battery clamps, and a portable carrying case. The wireless router may be a mesh network-based router, QDMA (Quad Division Multiple Access) router or ISM band wireless router. For instance, a MWR 6300 DC model wireless router sold by Motorola, Inc. may selectively be employed.

Using the expansion kit, individual expansion units may be deployed and set up to expand the wireless network coverage area up to, for example, a 0.5 mile line-of-site radius from each expansion unit. The expansion units are established by mounting the wireless router to the portable mast. The power cord attaches to the wireless router and the power source. Various power sources may be used in the field, such as a vehicle cigarette lighter outlet, a 12-volt battery (e.g. vehicle battery) or an AC outlet. To attach the power cord to a battery, the DC receptacle with battery clamps is preferably used, and to attach the power cord to an AC outlet, the AC-to-DC adapter may be used. Once the expansion unit is set up and power is applied to the wireless router in the field, the network range of communication coverage is extended and secure transfer of data to and from available network nodes is provided on the wireless network up to preselected distances such as 0.5 miles (line-of-sight) from each expansion unit.

The foregoing description of the preferred embodiments of the invention have been presented for purposes of illustration and description, and are not intended to be exhaustive or to limit the invention to the precise forms disclosed. The descriptions were selected to best explain the principles of the invention and their practical application to enable others skilled in the art to best utilize the invention in various embodiments and various modifications as are suited to the particular use contemplated. It is intended that the scope of the invention not be limited by the specification, but be defined by the claims set forth below.

What is claimed is:

1. A mobile video surveillance system comprising:
a plurality of portable video units communicating in a wireless network, wherein individual ones of the portable video units have a wireless router and a video camera held by a portable mounting device; and
a video server coupled with at least one other wireless router of the wireless network, said video server receives video data from the plurality of portable video units for display at the video server.

2. The mobile video surveillance system of claim 1, wherein the wireless network is at least one of: (a) an ad-hoc network, and (b) a mesh network.

3. The mobile video surveillance system of claim 1, wherein the wireless network is a self-forming network such that the portable video units are able to identify and communicate with additional portable video units that are added to the wireless network.

4. The mobile video surveillance system of claim 1, wherein the portable video units continue to communicate with each other and the video server when at least one of the portable video units is moved to a different location within the wireless network range of communication.

5. The mobile video surveillance system of claim 1, wherein each of the wireless routers of the portable video units and the at least one wireless router coupled with the video server are pre-assigned as network devices for the wireless network.

6. The mobile video surveillance system of claim 1, further comprising a plurality of portable power sources coupled with corresponding wireless routers of the portable video units.

7. The mobile video surveillance system of claim 6, further comprising an Ethernet connection and a power connection coupling the video camera and the wireless router of the portable video units.

8. The mobile video surveillance system of claim 7, wherein individual ones of the portable mounting devices comprise a mast with a tripod base.

9. The mobile video surveillance system of claim 8, wherein the individual ones of the portable mounting devices further comprise an inverted J-shaped pole releasably securable to the tripod base and wherein the video camera is attached to an end of the inverted J-shaped pole.

10. The mobile video surveillance system of claim 9, wherein the video camera is a pan-tilt-zoom Internet protocol-enabled video camera that is elevated from a ground surface by the portable mounting device.

11. The mobile video surveillance system of claim 6, wherein the wireless routers of the portable video units transmit video data received from the video cameras to the at least one wireless router coupled with the video server for real-time display of multiple video images captured by the video cameras.

12. The mobile video surveillance system of claim 11, wherein the video server further comprises a network video recorder coupled with a display device for simultaneous viewing of multiple video feeds received from the portable video units.

13. The mobile video surveillance system of claim 12, wherein pan, tilt and zoom operation of the video cameras is remotely controlled from the video server via the wireless network.

14. The mobile video surveillance system of claim 13, further comprising a power connection and an Ethernet connection between the video sever and the wireless router for the video server.

15. The mobile video surveillance system of claim 11, wherein the video server is coupled with a display device and a user interface, the video server, display device and user interface being operable in a vehicle such that control of the video camera operation via the user interface and display at the display device of multiple video feeds from the video cameras is performed as the vehicle moves to different locations within the wireless network.

16. A method of deploying a mobile video surveillance system comprising:
deploying a plurality of portable video units at select geographic locations for communication within a wireless network, individual ones of said portable video units having a video camera, a wireless router, and a portable mast;
positioning the video cameras for releasable securement at the portable masts such that the video cameras are placed in elevated positions;
connecting portable power sources to corresponding wireless routers of the portable video units; and
transmitting video data from the portable video units over the wireless network to a video server for display of a plurality of video images at the video server.

17. The method of claim 16, further comprising receiving the video data at another wireless router coupled with the video server.

18. The method of claim 16, further comprising moving at least one of the portable video units to a different geographic location within the wireless network range of coverage while maintaining video communication with the video server over the wireless network.

19. The method of claim 16, further comprising positioning the video server having an associated display device into a vehicle; and
simultaneously displaying multiple video feeds received from the video cameras at the display device as the vehicle moves to different locations within the wireless network.

20. The method of claim 16, further comprising deploying a plurality of expansion units to expand the wireless network coverage area, each expansion unit comprising a wireless router mounted to a portable mast; and
applying power to the wireless routers of the expansion units.
